(19) United States
(12) Patent Application Publication
(10) Pub. No.: US 2005/0137905 A1
(43) Pub. Date: Jun. 23, 2005

(54) METHOD AND SYSTEM FOR PRODUCING AN UPDATED AND RELIABLE HEALTH FORECAST GUIDE

(75) Inventors: DeAnn M. Haas, Germantown, WI (US); Bob L. Beckett, Waukesha, WI (US); Priya Gopinath, North Arlington, NJ (US)

Correspondence Address: ARTZ & ARTZ, P.C., 28333 TELEGRAPH RD., SUITE 250, SOUTHFIELD, MI, 48034, US

(73) Assignee: GE Medical Systems Global Technology Company, LLC, Waukesha, WI (US)

(21) Appl. No.: 10/707,488

(22) Filed: Dec. 17, 2003

(51) Int. Cl. G06F 17/60

(52) U.S. Cl. 705/2; 434/262

(57) ABSTRACT

A method and system (10) is provided for collecting a substantial amount of health-related data to create an updated and reliable health forecast guide. In one embodiment, the system (10) includes a central server (14) for storing health-related data and creating the health forecast guide based on the health-related data. This central server (14) is coupled to a series of remotely located computer workstations (12), which send the health-related data to the central server (14). Additionally, the remotely located computer workstations (12) are also utilized for downloading the health forecast guide from the central server (14).

### BACKGROUND OF INVENTION

The present invention relates generally to the determination of an individual's risk of illness, and particularly to a multi-user web-based network for collecting health-related data from a substantial number of people over one or more populations for the purpose of creating more accurate estimations of an individual's risk of illness.

As is well known, SMARTSCORE computed tomography (CT) provides a significant advance in the non-invasive evaluation of a patient's heart. SMARTSCORE CT can detect heart disease at a substantially early stage, before the onset of symptoms. A clear benefit of this CT is that it can allow a patient to take appropriate measures for preventing the disease from progressing or even allow the patient to reverse plaque build-up.

Specifically, SMARTSCORE CT is an ultra-fast CT scan that can acquire a series of high-resolution images of the heart in as little as 12 seconds. This scan can measure the amount of calcium in the patient's coronary arteries (also known as arterial plaque) and then assign the patient with a relative risk value for coronary artery disease. For example, the scan can assign a patient with a calcium score for comparison to a percentile-ranking guide. This percentile-ranking guide can indicate the risk category into which the patient falls. This percentile-ranking guide is usually based upon the patient's age, gender, calcium score, and other risk factors. It is understood that with more accurate and updated the percentile-ranking guide, patient evaluation will be more accurate and reliable.

Therefore, a need exists to provide a method and system for collecting health-related data from a substantial number of people over one or more populations in order to create a more reliable and accurate health forecast guide.

### SUMMARY OF INVENTION

The present invention provides a method and system for providing an updated and reliable health forecast guide, which is utilized in evaluating a patient's risk of illness.

The system includes a central server for storing health-related data. It is understood that various analytical methods can be used to process the health-related data and create the health forecast guide. The central server is coupled to a series of remotely located computer workstations for receiving the health-related data from those workstations. Additionally, the remotely located computer workstations are also utilized for receiving the health forecast guide from the central server and making the health forecast guide available to a local physician.

One advantage of the present invention is that a system is provided for creating an expansive database of health-related data, which can be utilized for creating more accurate estimations of an individual's risk of illness.

Another advantage of the present invention is the provision of a system for quickly collecting health-related data from one or more large populations to allow a health forecast guide to be created based on the most recent information.

Still another advantage of the present invention is the provision of a system that can collect health-related data from particular regions and allow a health forecast guide to be created either for those particular regions individually or for two or more of those regions as a whole.

Yet another advantage of the present invention is the provision of a system that can easily and regularly update a current health forecast guide.

Other advantages of the present invention will become apparent upon reading the following detailed description and appended claims, and upon reference to the accomanying drawings.

### BRIEF DESCRIPTION OF DRAWINGS

For a more complete understanding of this invention, reference should now be made to the embodiments illustrated in greater detail in the accompanying drawings and described below by way of examples of the invention. In the drawings:

FIG. 1 is a schematic view of a system for collecting health-related data to provide an updated and reliable health forecast guide, according to one embodiment of the invention; and

FIG. 2 is a logic flow diagram illustrating one method of operating the system illustrated in FIG. 1.

### DETAILED DESCRIPTION

The present invention is illustrated with respect to providing a health forecast guide particularly suited to determining a patient's risk of coronary disease. The present invention is, however, applicable to various other forms of medical studies, as will be understood by one skilled in the art.

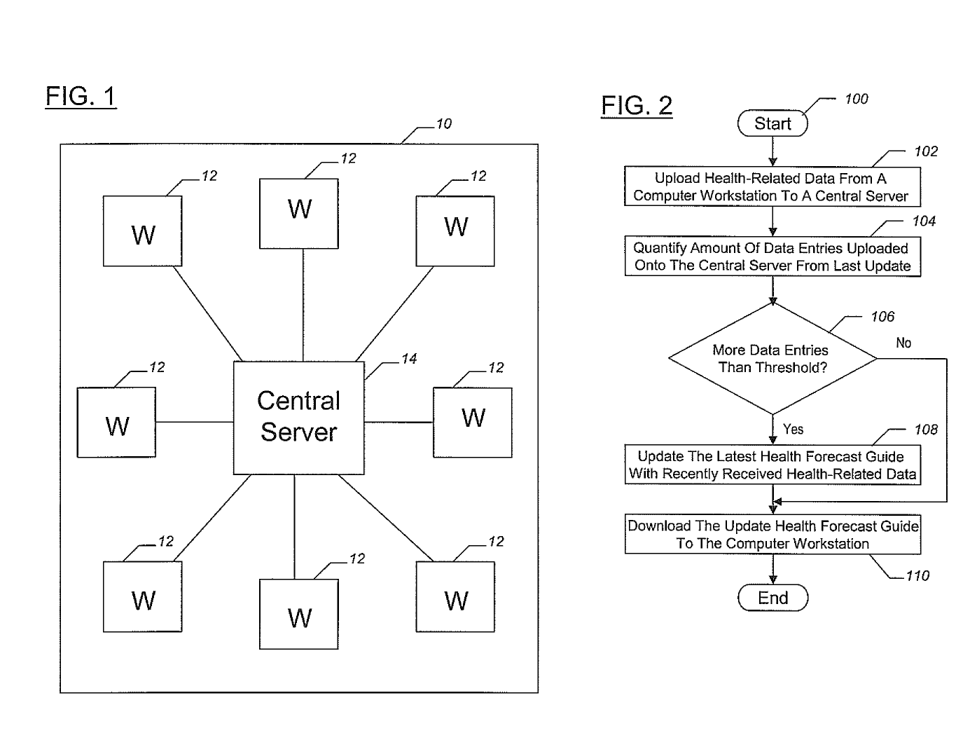

Referring to FIG. 1, there is shown a schematic diagram of a system 10 utilized for collecting a substantial amount of health-related data to create an updated and reliable health forecast guide, according to one embodiment of the invention. Preferably, the health-related data is obtained according to a single predetermined protocol. For example, with regard to coronary evaluations, the health-related data can be obtained according to a predetermined method of SMARTSCORE CT. Likewise, it will be appreciated that the specific method or protocol can vary depending upon the data to be attained. One of ordinary skill in the art will understand that the advantage of utilizing data obtained from an identical test procedure is that the comparisons between the data can be more meaningful and reliable.

The health forecast guide preferably is a percentile-ranking guide for assisting a physician in determining a patient's risk of cardiovascular disease. One of ordinary skill in the art will understand that the health forecast guide can be created based upon various kinds of analyses of the health-related data. The health-related data can include the patient's age, gender, exercise habits, smoking habits, cholesterol level, and calcium score. However, it will be appreciated that the health-related data can include various other kinds of coronary-related data or other non-coronary related data as desired.

It is also contemplated that the health forecast guide can instead be utilized for assisting a physician in diagnosing or prognosing various other illnesses. For example, with respect to lung cancer, the health-related data can include the patient's age, gender, smoking habits, nodule size, and nodule type.

The system 10 includes a series of computer workstations 12 located across a wide region. For example, the computer workstations 12 can be located in medical facilities across a state, a country, or even across the world. In one embodiment, these computer workstations 12 are coupled to a central server 14 by way of an internet connection. These computer workstations 12 are utilized for downloading the most recent health forecast guide. In this way, a physician can refer to the health forecast guide in determining his patient's risk of illness.

Referring now to FIG. 2, there is shown a logic flow diagram illustrating one method for operating the system 10 shown in FIG. 1. The sequence commences in step 100 and then immediately proceeds to step 102.

In step 102, a physician or other qualified technician utilizes one of the computer workstations 12 to upload a patient's health-related data to the central server 14. As described hereinabove, the health-related data can include the patient's age, gender, cholesterol level, exercise habits, smoking habits, calcium score, nodule size, and nodule type. However, it is understood that the health-related data can include various other kinds of data as desired. Furthermore, the health-related data is sent from one of the computer workstations 12 to the central server 14 via an internet connection. However, it will be appreciated that the computer workstations 12 can be connected to the central server 14 by a variety of suitable connections. The sequence then proceeds to step 104.

In step 104, the central server 14 receives the health-related data from one or more of the computer workstations 12 and stores this data in a supplementary database. The central server 14 measures the amount of data entries stored within the supplementary database. Then, the sequence proceeds to step 106.

In step 106, the central server 14 determines whether a threshold number of data entries have been received since the last time the health forecast guide was updated. If the central server 14 determines that the number of data entries exceeds the threshold number, then the sequence proceeds to step 108.

In step 108, the central server 14 transfers the data entries from the supplemental database to a primary database. In this way, the central server 14 utilizes both the recently uploaded health-related data and all of the health-related data previously stored in the primary database for the purpose of creating an updated health forecast guide. One of ordinary skill in the art will understand that various methods of analyzing the data can be utilized to create the updated health forecast guide. For example, the data can be merely charted to illustrate trends in a given population. Then, the central server 14 stores the updated health guide to its primary database and erases the data entries from the supplemental database. Then, the sequence proceeds to step 110.

However, if in step 106 the central server 14 determines that the number of data entries in the supplemental database does not exceed the threshold number of entries, then the sequence immediately proceeds to step 110.

In step 110, the central server 14 sends the most current health forecast guide to the workstation 12.

While particular embodiments of the present invention have been shown and described, numerous variations and alternate embodiments will occur to those skilled in the art. Accordingly, it is intended that the invention be limited only in terms of the appended claims.

1. A system for providing an updated and reliable health forecast guide, comprising:
a central server for storing a plurality of health-related data and creating the health forecast guide based on said plurality of health-related data; and
a plurality of remotely-located computer workstations coupled to said central server, said plurality of remotely-located computer workstations for receiving the health forecast guide from said central server and sending said plurality of health-related data to said central server.

2. The system of claim 1 wherein said plurality of health-related data comprises at least one of a patent age and a patient gender.

3. The system of claim 1 wherein said plurality of health-related data is collected according to an authorized protocol for maintaining reliability in obtaining said plurality of health-related data.

4. The system of claim 1 wherein said central server creates an updated health forecast guide when said central server has received a threshold amount of said plurality of health-related data.

5. The system of claim 1 wherein said plurality of remotely located computer workstations and said central server are interconnected by way of an internet network.

6. The system of claim 1 wherein said internet network provides said central server with said health-related data from a plurality of populations over a plurality of regions.

7. A system for providing an updated and reliable percentile ranking guide, comprising:
a central server for storing a plurality of coronary-related data and creating the percentile-ranking guide based on said plurality of coronary-related data; and
a plurality of remotely-located computer workstations coupled to said central server, said plurality of remotely-located computer workstations for receiving the percentile-ranking guide from said central server and sending said plurality of coronary-related data to said central server.

8. The system of claim 7 wherein said plurality of coronary-related data comprises at least one of a patent age, a patient gender, a patient cholesterol level, a patient exercise habit, a patient smoking habit, and a calcium score.

9. The system of claim 7 wherein said plurality of coronary-related data is collected according to a predetermined protocol for maintaining reliability in comparison of said plurality of coronary-related data.

10. The system of claim 7 wherein said central server creates an updated percentile-ranking guide when said central server has received a threshold amount of said plurality of coronary-related data.

11. The system of claim 7 wherein said plurality of remotely located computer workstations and said central server are interconnected by way of an internet network.

12. The system of claim 11 wherein said plurality of remotely-located computer workstations are located across at least one of a region, a country, and a plurality of countries for providing said central server with said plurality of health-related data from a plurality of populations.

13. A method for providing an updated and reliable health forecast guide, comprising:
employing at least one remotely located workstation to upload a central server with a plurality of health-related data;
downloading a current health forecast guide from said central server to said at least one remotely located workstation.

14. The method of claim 13 wherein said health-related data is directed to coronary disease and comprises at least one of a patient age, a patient gender, a patient cholesterol level, a patient exercise habit, a patient smoking habit, and a calcium score.

15. The method of claim 13 wherein said health-related data is directed to lung cancer and comprises at least one of a patient age, a patient gender, a nodule size, a nodule type, and a patient smoking habit.

16. The method of claim 13 further comprising:
quantifying an amount of said plurality of health-related data that is uploaded onto said central server.

17. The method of claim 16 further comprising:
determining that a threshold amount of said plurality of health-related data has been uploaded onto said central server.

18. The method of claim 17 further comprising:
sending said plurality of health-related data and said current health forecast guide via an internet network.

19. The method of claim 18 further comprising:
said sending said plurality of health-related data from a plurality of populations over a plurality of regions to said central server.

20. The method of claim 19 further comprising:
utilizing said plurality of health-related data for updating at least one of a local health forecast guide, a regional health forecast guide, a national health forecast guide, and a global health forecast guide.
